(19) United States
(12) Patent Application Publication
(10) Pub. No.: US 2003/0187991 A1
(43) Pub. Date: Oct. 2, 2003

(54) System and method for facilitating communication between network browsers and process instances

(75) Inventors: Raymond Lin, San Jose, CA (US); Min L. Ye, San Jose, CA (US); Brian Ligang Lou, Saratoga, CA (US)

Correspondence Address: David R. Stevens, Stevens & Westberg LLP, Suite 201, 99 North First Street, San Jose, CA, 95113, US

(73) Assignee: Agile Software Corporation, San Jose, CA

(21) Appl. No.: 10/202,130

(22) Filed: Jul. 23, 2002

Related U.S. Application Data
(60) Provisional application No. 60/363,400, filed on Mar. 8, 2002.

(51) Int. Cl. G06F 15/16; G06F 9/00

(52) U.S. Cl. 709/227; 709/107

(57) ABSTRACT

A system and method are provided for facilitating improved communication between a browser and a cluster of multi threaded process instances to perform services, such as accessing a database. The process instances are configured to communicate with other process instances in the cluster, and to communicate with and retrieve state information of particular instances from a central location. A cluster monitoring instance is also provided to separately monitor the operating states of a process instance and to enable operations that pertain to the state of these instances. A process monitoring instance may be configured to determine whether a process instance has terminated a session detected by the session monitoring instance. A rerouting instance may also be provided that is configured to recover browser session information in the event of a premature end of a session. An administrative instance is also provided to administer the cluster-specific properties of the cluster, including cache settings, communication protocols, and other properties. A device and method for the synchronization of cache storage are provided, allowing for the synchronization of the cache storage activity among the different process instances. The method provides for synchronizing cluster cache storage without increasing the traffic to the database. This enables the monitoring and possible recovery of state information and session data from a downed process instance by other instances in the cluster. This also enables scalability of the system by providing means to create virtually endless breadth to a cluster.

### RELATED APPLICATIONS

This application claims the benefit of U.S. Provisional Patent Application No. 60/363,400, filed on Mar. 8, 2002.

### BACKGROUND

The invention generally relates to systems and methods for communicating with computer servers on a computer network, such as application servers operating with the Internet, and, more particularly, to a system and method to facilitate communication between network browsers and process instances to provide scalability, the recovery of prematurely terminated browser sessions, and recovery of down instances.

Many systems and methods exist for connecting browsers with Internet application servers. An application server provides a service to the web browser (“browser”) by returning information in response to a browser request. A browser is an entity that communicates with other entities such as webservers via a network to search for information or services. One simple example of a browser is a person using a personal computer to search websites on the Internet to shop for goods or services. A more sophisticated example is one of a browser requesting information from a database that has an application server acting as an intermediary between the browser and the database. The browser may request database information via the application server, rather than directly accessing the database. The application server can provide a response without giving the browser access to the database, keeping the database secure, and managing the transactional traffic of the database. In a traditional client/server system, the communication protocols are based on a client-request/server-response model. In this model, the client, or Internet web-browser, connects to a server connected to the network, such as the Internet, according to a well-defined protocol. The server, such as a webserver or an application server, then receives the browser request and processes it. In response, the server sends a result back to the browser. The result could take the form of a data file that can be displayed as content on a monitor, a software application that can perform certain tasks, or other data files that are commonly transferred over networks. Once the browser downloads the result, the process is complete. This transaction could occur between a browser and an application server as well as other entities.

Most systems and methods configured to perform this initial connection have at least one common attribute, when the client assessing the server sends a request to establish the initial connection, the server accepts it passively and collects enough client information to verify the client and establish an identity for a session. Problems occur, however, when application servers are taken out of service during a session. This can frustrate a web browser when a session is prematurely terminated. Conventional systems exist that provide redundancy in application servers in order to back up other application servers. These are known as parallel servers. In most applications, the redundant application servers do not communicate amongst each other regarding their state and do not synchronize. Without synchronization, it is difficult if not impossible to recover lost sessions with browsers. As a result, sessions are terminated. It is also difficult, if not impossible, to break up certain tasks requested by anyone browser to be performed in separate application servers. Data cannot be shared among servers, because the data integrity cannot be guaranteed. Essentially, application servers must be duplicated.

In some applications, redundant servers synchronize to some extent via the database. This causes a problem, however, because each of the application servers must constantly access the database to monitor any changes in data. This is because changes in data can be committed at any time by any other application server while creating, retrieving, updating and deleting data in the common database. Thus, each application server must be aware of whether any data in the database is committed to any other server. In order to do this, the redundant application servers must constantly access the database in an attempt to synchronize with other application servers to monitor their individual states. Also, whenever application servers are added to the system, the database is more loaded down, because accesses to the database are more frequent. Moreover, with more application servers, more computations are required within the database, loading it down even further.

Furthermore, multiple points of failure exist in such systems, where sessions with browsers may be dropped and not recovered. This greatly reduces scalability of a system. The browsers are then left to recover sessions by contacting another application server and starting sessions over again from the beginning. In conventional web browser applications, browsers simply transmit requests and expect responses from application servers in response. Thus, sessions only truly exist in the application servers by recording the series of requests and associated responses that occur between a browser and an application server. Thus, the onus is on the application server to establish and maintain session information with the browser. Once the application server is out of service, the session information is typically lost, and the browser is left to re-establish contact with another application server.

Therefore, there exists a need for a method and apparatus for better servicing browsers that wish to initiate and maintain sessions with application servers. As will be seen, the invention accomplishes this in an elegant manner.

### SUMMARY OF THE INVENTION

A system and method are provided for facilitating improved communication between a browser and a cluster of multi threaded process instances. These process instances are each configured to communicate with browsers sending browser requests and to perform services, such as accessing a database. The instances may be hosted in an application server that is configured to run the instances. The process instances are configured to communicate with other process instances in the cluster, and to communicate with and retrieve state information of particular instances from a central location. A cluster interface allows each process instance to monitor other process instances within the cluster, providing robust recovery capabilities for the system. A routing device may be configured to manage load balancing among the active instances in the cluster, and to route incoming browser requests accordingly. A cluster monitoring instance is also provided to separately monitor the operating states of a process instance and to enable operations that pertain to the state of these instances. A process monitoring instance may be configured to determine whether a process instance has terminated a session detected by the session monitoring instance. A rerouting instance may also be provided that is configured to recover browser session information in the event of a premature end of a session. In such an event, an alternative process instance is directed to recover the session, to assume the connection with the browser and to resume the browser session. This may be performed in a manner that is transparent to a user operating a browser device. An administrative instance is also provided to administer the cluster-specific properties of the cluster, including cache settings, communication protocols, and other properties.

Alternatively, a device and method for the synchronization of cache storage are provided. The device and method allow for the synchronization of the cache storage activity among the different process instances. Each cache storage is associated with an individual process instance, providing independent cache storage for each instance. The method provides for synchronizing cluster cache storage without increasing the traffic to the database. This enables the monitoring and possible recovery of state information and session data from a downed process instance by other instances in the cluster. This also enables scalability of the system by providing means to create virtually endless breadth to a cluster.

### BRIEF DESCRIPTION OF THE DRAWINGS

FIG. 1 is a block diagram of a network system employing a clustered eHub system according to the invention;

FIG. 2 is a block diagram of a network system employing a clustered eHub system according to the invention;

FIG. 3 is a table illustrating the start up procedure for an eHub instance according to the invention;

FIG. 4 is a flow diagram illustrating the process of monitoring eHubs during sessions according to the invention;

FIG. 5 is a flow diagram illustrating the administration of a session between a browser and an eHub according to the invention;

FIG. 6 is a flow diagram illustrating the process where a webserver facilitates a session between a browser and an eHub according to the invention;

FIG. 7 is a flow diagram illustrating alternate processes for detecting whether an eHub is down according to the invention;

FIG. 8 is a flow diagram illustrating the recovery process for recovering a session according to the invention;

FIG. 9 is a flow diagram illustrating the recovery procedure for a down eHub according to the invention;

FIG. 10 is a block diagram of an eHub instance according to the invention;

FIG. 11 is a block diagram of an application server according to the invention; and

FIG. 12 is a flow diagram illustrating the procedure for negotiating object write locks among clustered eHub instances according to the invention; and

FIG. 13 is a flow diagram illustrating the eHub shut-down procedure performed by the eHub cluster monitor according to the invention;

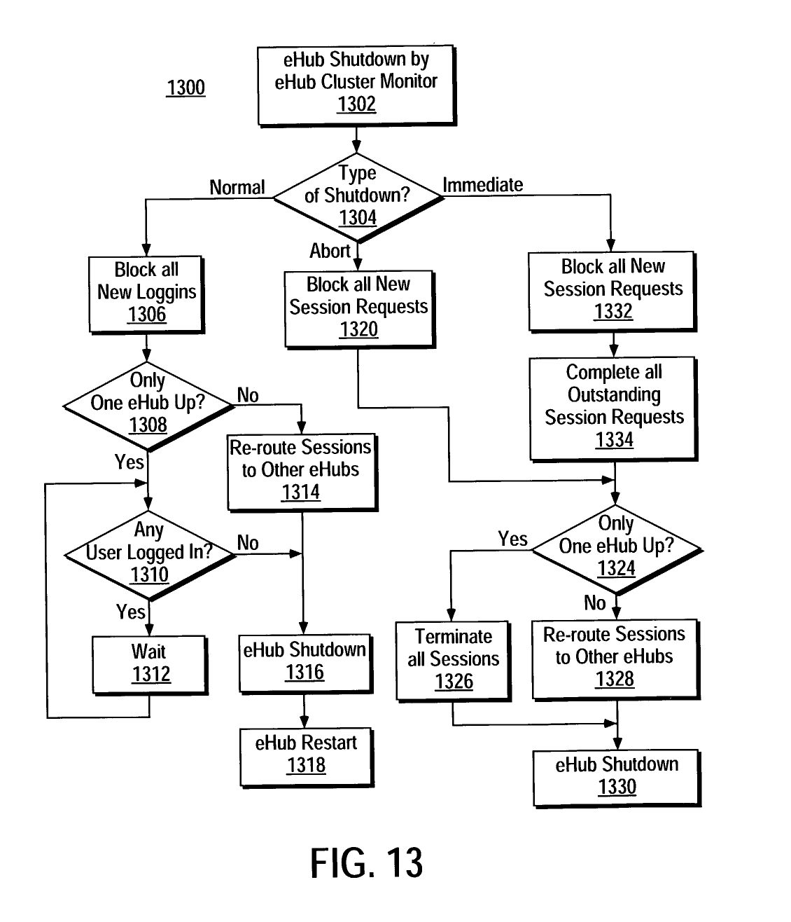

### THE DETAILED DESCRIPTION OF THE INVENTION

The invention provides a system and method for facilitating communication between a browser and process instances. According to one embodiment of the invention, the application server includes a cluster of multi threaded process instances. These process instances are each configured to communicate with browsers sending browser requests and to perform services, such as accessing a database. The process instances are configured to communicate with other process instances in the cluster to share operation state information and other information to each other. One method provides for each instance to transmit and retrieve state information from a central location such as a database. In a preferred embodiment, the central location is a separate entity from the device or entity that hosts the process instances. Such a hosting entity may be a database. This would ensure security and preserve process session information in the event that the hosting entity shuts down. Each process instance has a cluster interface configured to enable communication with each of the other instances. This allows each instance to monitor other instances within the cluster, and to provide recovery to any failed instance.

A session routing instance may be configured to respond to load balancing criteria among the active instances in the cluster, and to route incoming browser requests accordingly. In one embodiment, the instance is embodied in the webserver, which acts as a host for the instance and is configured to perform the related functions. When a request is directed from a browser, the routing instance contacts the process instance indicated in the request, and determines whether the process instance has the capacity to respond to the request. If it does not, the request may be directed to an alternative process instance.

Once a session begins, a session monitoring instance may be configured to determine whether a process instance has terminated a session. In one embodiment, the instance is embodied in the webserver, which acts as a host for the instance and is configured to perform the related functions. The monitoring instance may keep a log of transactions and other session information for posterity. In the event a session is prematurely terminated, certain session data is made available, and recovery of the session may be attempted. In a planned outage of a process instance for maintenance for example, all of the session data may be transferred over to an alternate instance, and the session can continue seamlessly and transparently from a user on the browser end.

A session rerouting instance may also be provided that is configured to recover browser session information in the event of a premature end of a session. In such an event, an alternative process instance recovers the session, assumes the connection with the browser and resumes the browser session. In one embodiment, the instance is embodied in the webserver, which acts as a host for the instance and is configured to perform the related functions. In a configuration the monitoring and session recovery is performed in a webserver, the webserver is the first to be aware of session failures, whether it is a failed instance or a failure of the entity that hosts it. This may be performed in a manner that is transparent to a user operating a browser device.

A cluster monitoring instance may be provided to separately monitor the operating states of a process instance and to enable operations that pertain to the state of these instances. Such an instance could be established as supervisory entity for monitoring the cluster activities, and set defaults for certain operations. The cluster monitoring instance may also perform operations for shutting down the operations of process instances for maintenance or other purposes. In one embodiment, the cluster monitoring instance may be configured to establish capacity tolerances of process instances for load balancing purposes. For example, the cluster monitoring instance may establish one process instance as an exclusive service provider for a large client, keeping it available for upcoming requests. Such a client may require high demand access, possibly with large surges in demand for certain services. The cluster monitoring instance may then be configured for establishing process instances as an exclusive provider for the client. This is discussed in more detail below.

Alternatively, an administrative instance may be provided to administer the cluster-specific properties of the cluster, including cache settings, communication protocols, and other properties. In one embodiment, the administrative instance may be configured as an administrative node tree. The administrative instance may reside in an application server that hosts the process instances, or in any other entity convenient for hosting such an instance. In such an application, cluster-specific properties may be established as properties of this node. The administrative instance may be configured to perform administrative tasks including managing user accounts for a user based application, managing business rules established by a particular business utilizing an application, setting up privileges for hierarchical control of access in an application and defining workflow algorithms for controlling tasks in an application.

In one embodiment, the webserver is configured with an cluster monitor to monitor and manage the connection between the browser and the process instance, facilitating communications during a session. Upon receipt of a request from a browser, the webserver searches for a process instance that is able to respond to the request. Initially, it contacts the process instance provided in the browser request. Then, there is an initial communication process that occurs that includes hand shaking routines between the webserver and the process instance. This process includes sending the webserver alternate addresses of process instances to contact in the event of a premature termination of a session. The webserver may also request properties and load balancing information to determine the load. To manage incoming browser requests, the invention may include a load balancing device, or load balancer, that is configured to receive and screen browser requests. The load balancer may then direct the requests among the plurality of process instances. The load balancer is configured to balance the incoming load of browser requests among the process instances. Once connected, the process instances may be configured to communicate amongst each other to share status information related to communication sessions with browsers.

If the process instance is too overloaded to handle the request, the webserver may then contact an alternate process instance to take on the session. Once a process instance is found, the webserver creates a communication thread with the process instance and initiates a session between the browser and the process instance. The process instance then receives the request, provides a service or process, and produces a result.

The process instance may reside on an entity, such as an application server or similar entity, where the entity acts as the host of the process instance. The hosting entity is configured to run such instances of computer processes and to perform communication operations and transactions with a database. Depending on the application, a system may include multiple hosting entities, e.g., multiple application servers, or may also include multiple instances hosted on one or more application servers. The invention provides dramatic scalability and recovery capabilities in any system configuration.

To further facilitate scalability and recoverability, a device and method for the synchronization of cache storage are provided. The device and method allow for the synchronization of the cache storage activity among the different process instances. Each cache storage is associated with an individual process instance, providing independent cache storage for each instance. The method provides for synchronizing cluster cache storage without increasing the traffic to the database. This enables the monitoring, scaling, and possible recovery of state information and session data from a downed process instance by other instances in the cluster.

In one embodiment of the invention, a webserver is configured with a session routing instance for routing incoming browser requests to one of a cluster of process instances, which may be hosted in application servers. A load-balancing instance is configured to monitor the loads of process instances while routing incoming requests. The webserver is further configured with a rerouting instance configured to reroute sessions that may prematurely terminate. One embodiment provides means for the process instances to communicate amongst each other and to monitor each other. In operation, the webserver may receive a browser request directed to a process instance. Once that occurs, the webserver facilitates a communication connection that allows the browser to communicate with an entity such as an application server that hosts the instance. In different embodiments, different configurations of application servers that host process instances may exist. For example, multiple redundant application servers may be configured to host a multitude of process instances. Such configurations are dependent on particular applications. The webserver may host the cluster monitoring instance to monitor the communications between the application server and the browser. In one embodiment, this information may serve as a log of activity between the browser and the application server, detailing the history of data transactions during a session. Such log information may include the time duration of the session, particular transactions that occurred and the order in which they occurred, identity of the browser, identity of the application server, identity of the process instance performing the session and other information. The log may contain different combinations and permutations of these types of information according to a particular application.

In normal operation, there are times when a process instance terminates operations. This may occur when an application server or other entity hosting the process instance is taken out of service. For example, a server may need to be taken down for service or maintenance. Termination may also occur as a result of an operational failure that renders the application.server inoperable in the system. According to the invention, in the event an instance ceases to operate, whether or not it occurs during an ongoing session with a browser, the logged information related to the session is retained. Where possible, the cluster monitor will carefully transfer all current or pending sessions to other instances so that the sessions may continue.

If a process instance terminates operations during an ongoing session, the webserver would be the first to detect such a premature termination. This is because the webserver, which monitors the ongoing sessions, is in frequent communication with the browser and the process instance during a session. The webserver, which retains the addresses of other process instances, can then locate and reconnect with another process instance to continue the session with the browser. The new process instance can retrieve the session information and configure itself according to the former session. Once the webserver, the new process instance and the browser are connected, the session between the browser and the application server may continue.

A process instance may be shut down at a time when no sessions are occurring, since the webservers would not be in constant contact with the browser and process instance during this time, they would not likely be the first entity aware of the termination of services. According to the invention, the other process instances within the cluster periodically monitor the status of each other. When a process instance detects the termination of another process instance, it can initiate a recovery process for the downed process instance. This is discussed in more detail below.

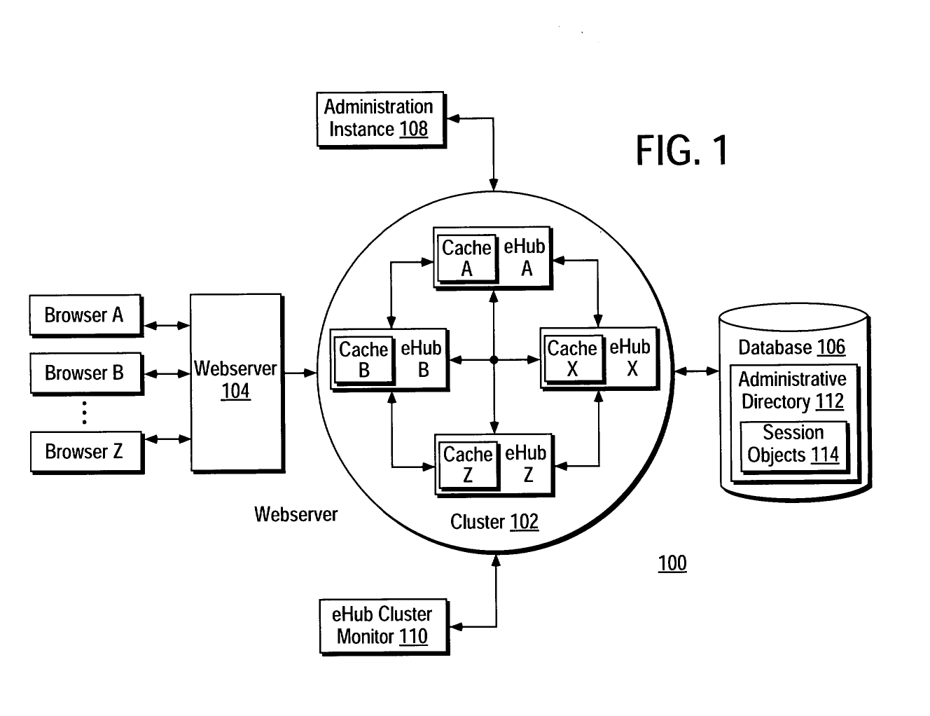

Referring to FIG. 1, an example of a system embodying the invention is illustrated. In the system illustrated, processes instances are represented as eHubs. In this embodiment, eHubs are process instances configured to receive browser requests sent by browsers to the eHubs via a webserver to access information from a database. The eHubs may perform calculations or various processes on the data to produce a result that is responsive to a request. The system 100 includes an eHub cluster 102 made up of a plurality of eHubs, eHubs A-Z, configured to communicate with each other. The eHub cluster communicates with a webserver 104. Given the scalability provided by the invention, the cluster may be made up of any number of eHubs. The webserver communicates with Browsers A-Z, to receive browser requests for service from the various eHubs. In one embodiment, the eHubs are configured to access database 106 to retrieve data requested by browsers.

According to the invention, the eHubs are configured to account for and maintain session connections with the browsers. The eHubs operating as a cluster are further configured to monitor each other's state information. In one embodiment, each eHub periodically accesses a table or directory in the database that contains the state information of each eHub. In the event that an eHub fails to check in within a predetermined period, the other eHubs are alerted, and recovery operations commence. Utilizing the invention, this can be done with minimal access to the database. The system further includes administration instance 108, which may be established as an advanced form of a browser. The administrative instance is a configurable tool for maintaining cluster specific settings and properties. The administration instance is configured with privileges to develop and maintain the operational settings of the various eHubs within the cluster. The system further includes eHub cluster monitor 110 configured to monitor the operations of the eHubs within the cluster. The eHub cluster monitor is configured to communicate with the database to monitor the administrative directory 112 of eHubs configured within the cluster. The cluster monitor may further be configured to instantiate eHubs, remove eHubs and to redirect ongoing sessions to other eHubs.

In operation, the browsers transmit browser requests destined for particular eHubs the webserver 104. The webserver operates to govern the connections between the browsers and the eHubs. The administration instance 108 can be configured to manage the traffic control between the browsers and the eHubs in many ways. One function of the webserver is to perform load balancing analysis among the eHubs in order to properly route browsers to eHubs for service. Once the routing operation is completed, a browser is connected to a particular eHub, and a session is initiated. During a session, the eHub designated for the browser accesses database 106 to retrieve data in response to the browser requests. The webserver monitors the operation during a session. The eHub cluster monitor performs general eHub management. The eHub cluster monitor may be configured to govern the dedicated eHubs that may be established for exclusive access by select browsers. For example, a customer that requires a high-capacity process instance for a high amount of browser traffic may want to have a dedicated process instance to serve its requests. Such exclusivity may include exclusive access during particular time periods, exclusive access of limited duration, or specialized services that are custom configured in a particular eHub instance. In one configuration, the administration instance an eHub cluster monitor may operate together. They could also operate as a single instance to monitor and administer the cluster.

In the event that an eHub terminates operation, eHub recovery procedures are provided that allow the system to recover the operations of the eHub. In order to enable eHub recovery processes, administrative directory 112 is maintained within the database in order to retain information related to the eHub operations as well as sessions that may be in operation when an cHub terminates operation. Upon recovery of an eHub, the other eHubs in the cluster operate to isolate and recover any of eHub that ceases operation by periodically examining the administrative directory within the database. Also, each eHub periodically updates to the administrative directory in order to inform the other eHubs of its state and status.

In one embodiment, a downed eHub may be detected by ascertaining whether it has checked in to the administrative directory. The eHubs are configured to check in periodically, and register a timestamp to indicate when they checked in. When any one eHub retrieves a copy of the directory, it can analyze the timestamps, and can determine when other eHubs have checked in. If they have not checked in within a certain period, 10 minutes for example, an alert to recover the eHub may be appropriate. Upon discovery of a downed eHub, the discovering eHub may initiate recovery procedures.

Session recovery processes are provided that recover the operations of an ongoing session between a browser and an eHub. In the event that an eHub terminates operation during an ongoing session, the session information may then be retrieved by another eHub that is assuming the session. This is done by retrieving a session object from session objects storage 114 from the database. A session object contains the relevant session information required to assume and recover the ongoing session from an eHub that has prematurely terminated operations. The session may then be recovered by another eHub, and can even operate transparently to the browser.

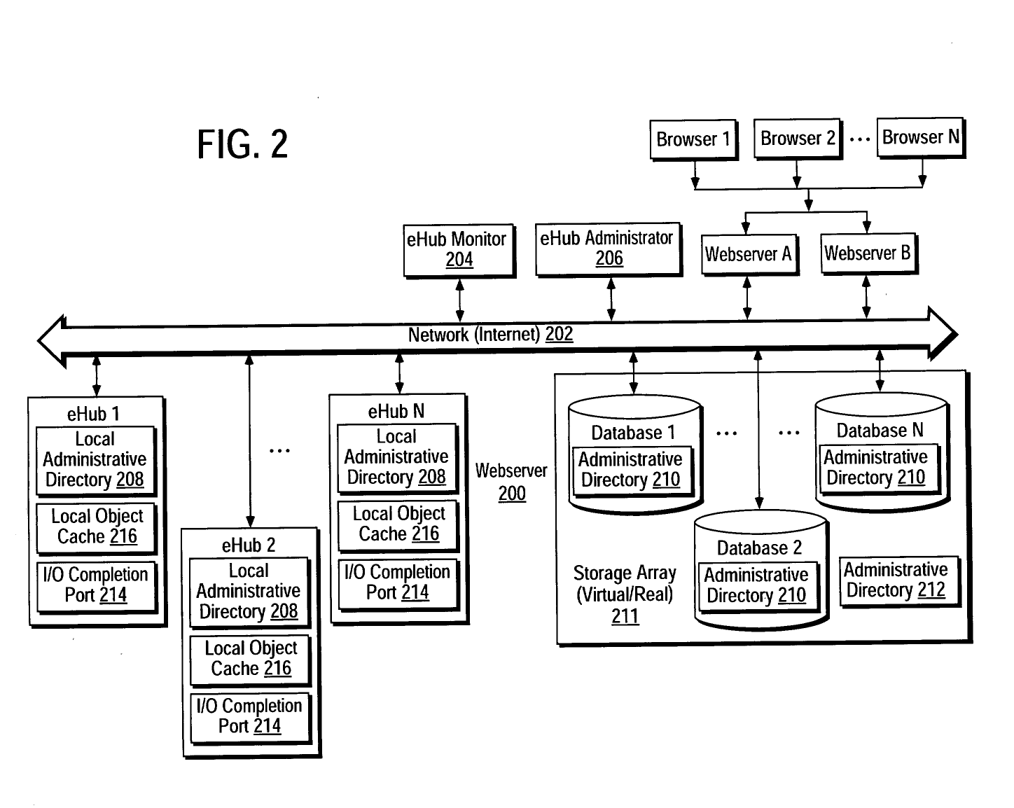

Referring to FIG. 2, a system 200 is illustrated in the context of a network configuration. Similar to the system 100 of FIG. 1, the system 200 and is made up of a plurality of browsers, Browser 1, Browser 2 . . . Browser N, connected to webservers A and B. The network may be the Internet, intranet or other medium configured to interconnect electronic entities. Also connected to the network are eHubs, 1, 2 . . . N, which are configured to access databases 1, 2 . . . N. EHub monitor 204 and eHub administrator 206 also communicate with network 202, giving them access to the various eHubs. Depending on the application, either one or multiple webserver may be utilized in order to provide redundant systems for browser access. According to the invention, the eHubs may communicate with each other in a manner that allows eHub access to any other eHub that is configured within the cluster. This access allows for the connected eHubs to monitor each other, and possibly recover any eHub that goes down.

Still referring to FIG. 2, each eHub includes a local administrative directory 208 that contains the status information of each eHub in the cluster. The local administrative directory is retrieved from the cluster database that contains the administrative directory 210, which is updated by each eHub. In operation, each eHub retrieves the administrative directory and copies it into its local administrative directory. In its monitoring process, an eHub examines the administrative directory contents when it is retrieved from the administrative directory of the database. Each eHub can update its administrative directory 214 by retrieving administrative directory 210. If the eHub determines that another eHub has terminated operation, recovery processes can be initiated.

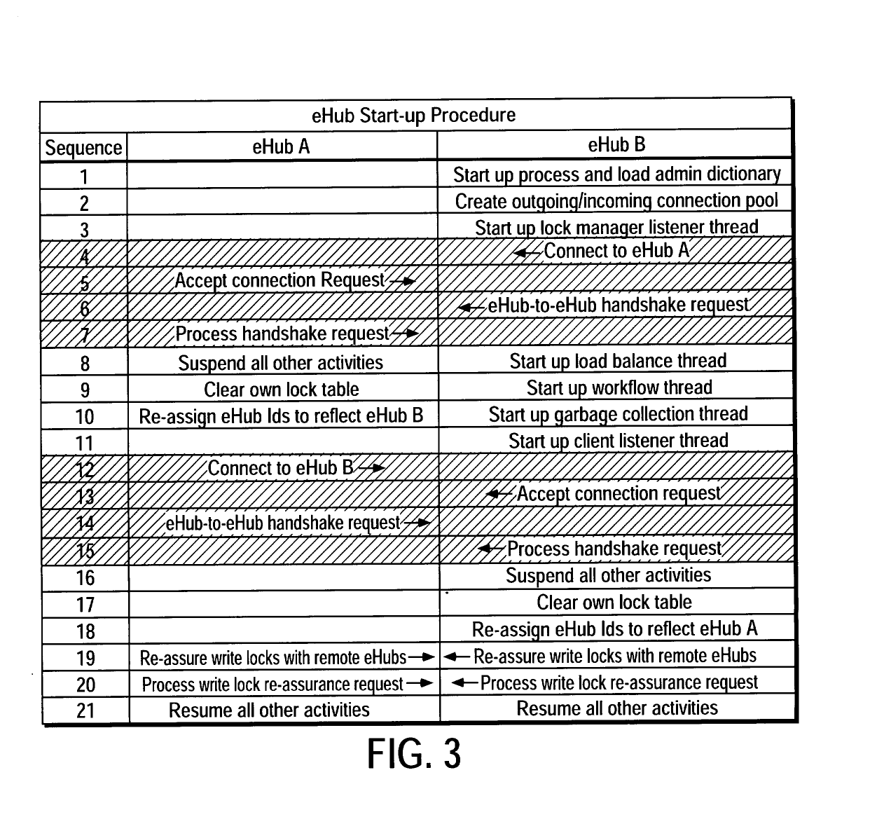

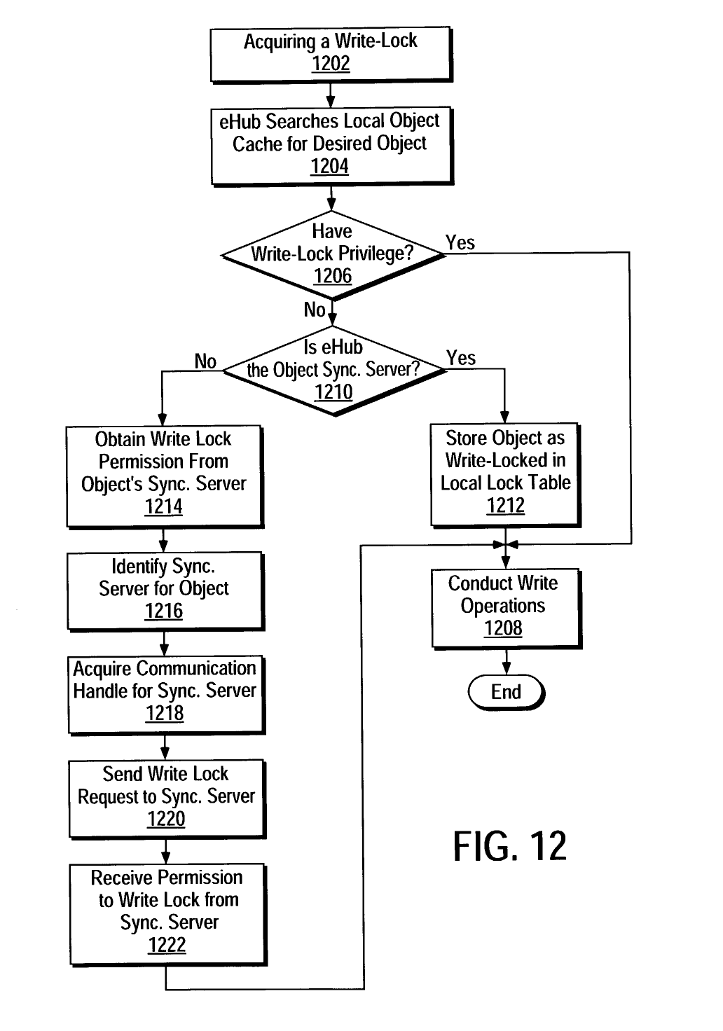

One or more databases may be arranged in a storage array 211. These databases may be configured as an actual storage array with multiple servers containing separate databases. The databases may also be configured as a virtual storage array, where virtual databases exist within a singular entity, such as a database server. Virtual databases are well known to those skilled in the art, and may be configured in different manners. The storage array may include a general administrative directory 212, which acts as a general administrative directory for the eHub cluster that is configured to access the storage array. Each eHub may further include an I/O completion port 214. The completion port is configured to multiplex server to server communications among the eHubs in the cluster. Connections among the various completion ports are established when an eHub is incorporated into the cluster, as described below in connection with FIG. 3. These connections are utilized among the various eHubs to communicate status information to each other, and to facilitate read lock and write lock requests between the synchronization servers and other eHubs, as is discussed below in connection with FIG. 12. Each eHub further includes its own local object cache 216. The local object cache gives each eHub its own cache storage for use during normal operation. This local cache storage allows each eHub to store object information, whether the eHub is the synchronization server, or if it is utilizing an object that is hosted by another eHub acting as the object's synchronization server.

In operation, browsers send requests to the webserver. The webservers receive the requests and route them to appropriate eHubs for service. In one embodiment, a webserver may have the address of one single eHub to which a browser request is directed. Once the request is routed to the eHub, the webserver may then be informed of all of the other eHubs that are interconnected within the cluster. This is accomplished by the eHub transmitting a list of addresses of alternate eHubs within the cluster from its local administrative directory. This gives the webserver alternate eHubs in which to route browser requests. Once the webserver is aware of the other eHubs, it performs load balancing operations, the browser requests are routed to appropriate eHubs that may not be so overloaded with other requests. In one embodiment, certain requests might be handled by particular eHubs only, and need to be routed accordingly. In one embodiment, a webserver may access an eHub, requests a status report of the eHubs workload, and make an evaluation of whether a pending browser request is appropriate for that eHub. If it is not, then the webserver may route the request to another eHub that is more appropriate. An eHub is then established as the recipient of the browser request. The session then begins.

In the operation of a session, a webserver routes requests and responses between a browser and an eHub. The eHub accesses a database to retrieve data in response to the browser request. If an eHub prematurely terminates a session, the webserver would be the first entity to detect such a termination. In response, and according to the invention, the webserver may operate to find another eHub that can take over the session operations. This can be done transparent to the browser. The webserver would have a list of the eHub addresses and would be able to perform another load balancing operation while choosing an appropriate eHub to take over the session operations. These operations are discussed in more detail below.

Referring to FIG. 3, a table illustrating the operations of an eHub startup is illustrated, where an eHub is incorporated into the cluster. In order for an eHub cluster to perform, eHubs must start up and be interconnected with other eHubs. The table of FIG. 3 illustrates the sequence of operations between two eHubs, eHub A and eHub B, during such a Start up process. In one embodiment, the connection between any two eHub instances is implemented as a pool of TCP socket connection handles. Such connections are well-known by those skilled in the art. The table illustrates the different processes and handshake routines between any two eHub instances during a Start up. In this example, eHub A is up and running and eHub B is starting up and being brought into the cluster by eHub A. As a legend, the shaded areas of the table illustrate serialized operations, where each eHub takes turns sending information to the other eHub. Also, the arrows denote remote operations, whereby signals are sent from one eHub to the other.

In step 1, the administrative directory is loaded the eHub B from the database to begin the process. The administrative directory contains a list of all eHubs that are configured within the cluster along with basic eHub identification information. In step 2, an outgoing and incoming connection pool is created in eHub B The outgoing connection pool contains a set of connection handles through which requests can be sent to a remote eHub. The incoming connection pool contains a set of connection handles through which requests can be received from a remote eHub. Here, requests refer to eHub-to-eHub communications such as write lock negotiation, clock synchronization, heart beat information exchange and other communications among eHubs.. In step 3, a Start up lock manager listening thread is established in eHub B. This lock manager allows eHub B are to listen for lock protocol signals, as discussed in more detail below.

In the next four steps, a serialized operation occurs between eHub A and eHub B to establish a connection. According the invention, eHub B, being the eHub starting up and establishing itself within the new cluster, performs these four operations with each and every eHub in the cluster. This establishes the interconnected network of the cluster required for the monitoring and possible recovery of an eHub by other eHubs. In step 4, an initial connection signal is transmitted from eHub B to eHub A to establish a connection. In response, in step 5, eHub A transmits a connection acceptance signal to eHub B. In response to the signal, in step 6, eHub B transmits an eHub-to-eHub handshake request back to eHub A. In step 7, eHub A transmits a process handshake request to eHub B. In the next four steps, the communicating eHubs perform independent processes. In step 8, eHub A suspends all other activities within the cluster in order to establish the identity of the eHub B into the cluster.

In a clustered environment, process instances run on different machines which could potentially have different (or inaccurate) time settings. For example, assume User A1 executes a transaction through process instance P1 at time T1 and User A2 executes another transaction through process instance P2 at time T2. Further assume that time T1 occurs before T2. Then it is possible that the value of T1 recorded by P1 appears later than that of T2 recorded by P2. This is due to incorrect time settings on the instance of either P1 or P2. This would be a disaster if some of the business processes are sensitive to sequence of event occurrences. A conventional method of solving this problem is to have every process instance contact a global time server to adjust its time when the instance first starts up. This is not always possible, because a standard time server may not be always available. In a preferred embodiment of a clustered eHub, the problem is solved by having eHub instances negotiate and agree on a standard time among themselves. The process of this negotiation is called Clock Synchronization, which may occur periodically over time, for example every 90 seconds among all eHub instances. In step 9, eHub A clears its own lock table and in step 10 re-assign all eHub IDs to reflect the new identification of eHub B. The reassignment of the eHub IDs is dynamic and facilitates the cluster's ability to manage the eHubs as they are added and removed from the system. Reassigning IDs can act just as changing a phone number. When an eHub terminates operations, whether it is intentionally taken off line or somehow fails, the reassignment of the ID can allow subsequent browser requests to be directed to a new eHub, avoiding any breaks in request services. The reassignment may generally acts to effectively take an eHub offline, rendering it unable to access other eHubs or any databases. The reassignment also prevents other eHubs from contacting the offline eHub. This avoids any conflicts in browser communications, inter-cluster cache exchanges, read and write locks, or other transmissions among the clustered eHubs.

Referring back to step 8, eHub B performs its own operations, and starts a load balance thread. This allows the cluster and the webservers to evaluate the load balance with respect to eHub B. In step 9, a workflow thread is started. The workflow thread is responsible for sending email notifications to users as a result of certain business processes. In step 10, a garbage collection thread is established in order to empty the cache of any stale data. In step 11, eHub B establishes a client listener thread to allow eHub B to receive signals from a client, such as a webserver sending a browser request to eHub B. Once again, the next four steps are a serialized process, where signals are sent in sequence between eHub A and eHub B. In step 12, signal is sent from eHub A to connect to eHub B. In response, in step 13, eHub B sends a signal to accept the connection request from eHub A. In response, in step 14, eHub A transmits an eHub-to-eHub handshake request to eHub B. In step 15, eHub B transmits a Process handshake request signal back to eHub A, acknowledging the handshake. In step 16, eHub B suspends all other activities, clears its own lock table in step 17 and reassigns eHub IDs stored within eHub B to reflect the existence of eHub A in the new cluster formed between eHub A and eHub B. In step 19, each of the eHubs transmits a command to re-assure write locks with remote eHubs A and B sent to each other. In step 20, each eHub A and B transmits a process write lock re-assurance request to the other. In step 21, each eHub resumes all other activities.

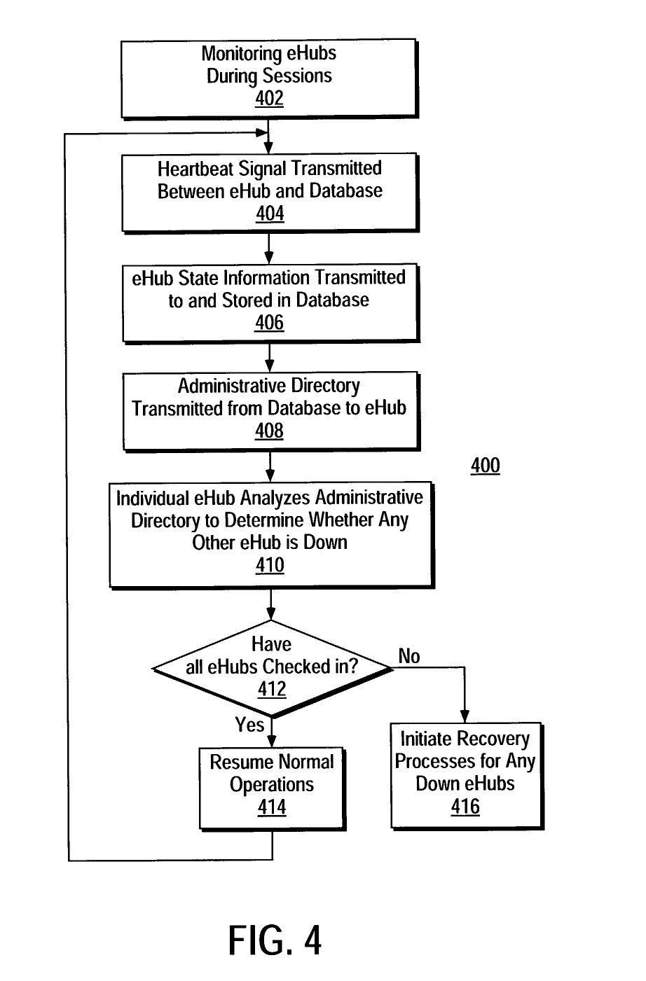

Referring to FIG. 4, a flow diagram 400 is shown to illustrate a Process for monitoring an eHub during sessions. The process begins his step 402. In step 404, a heartbeat signal is transmitted between an eHub and a database. This heartbeat signal is transmitted periodically from each every eHub within the cluster in order to provide a constant indication of the operational viability of each eHub. In step 406, state information of each eHub is transmitted to and stored in the database for posterity.

The amount of eHub state information transmitted and retained in the database depends on the particular application. In a preferred embodiment, judicious use of database space and is exercised to reduce the access traffic to the database. The mere transmission of information to the database is evidence that the eHub is running. Therefore, for self-monitoring the eHubs, separate status information need not be transmitted. In one embodiment, to facilitate session recovery, session information such as browser IP addresses, user licenses and other long-in information is transmitted. In a preferred embodiment, excessive information such as frequently sent session requests is not retained. The reason is that they take up too much space, they occurred to frequently (increasing traffic to the database), and are not necessary to recover a prematurely terminated session. In practice, if an eHub terminates operation during a session, a browser would not need to login again, but would be rerouted automatically and transparently to another eHub to continue the session. Some session information may be lost due to a premature termination of operations. However, the essential information needed to recover the session connection is retained in the session object stored in the database. In contrast, an intentional shutdown of an eHub by the eHub monitor may transmit all session information from the eHub being shut down to the new alternate eHub. This operation allows the session to continue in a virtually transparent manner to the browser.

Each eHub transmits its state and session information to the database. This way, an administrative directory is transmitted from the database to each eHub, giving each eHub's status information to each other eHub. Once this is received, in step 410, each individual eHub analyzes the administrative directory to determine whether any other eHub is down. In step 412, query is initiated to determine whether all eHubs have checked in by sending a heartbeat signal to the database. In one embodiment, the heartbeat signal is a signal that is periodically sent from an eHub to the database. The signal includes information related to the state information for the eHub that is transmitting the signal. The signal may further include information related to any ongoing sessions between the transmitting eHub and a browser. If all eHubs have checked in with their heartbeat signal, normal operations resume in step 414 were each eHub continues to transmit heartbeat signals to the database back in step 404. If, however, an eHub had not checked in, the process proceeds to step 416 where a recovery processes is initiated for any down eHub.

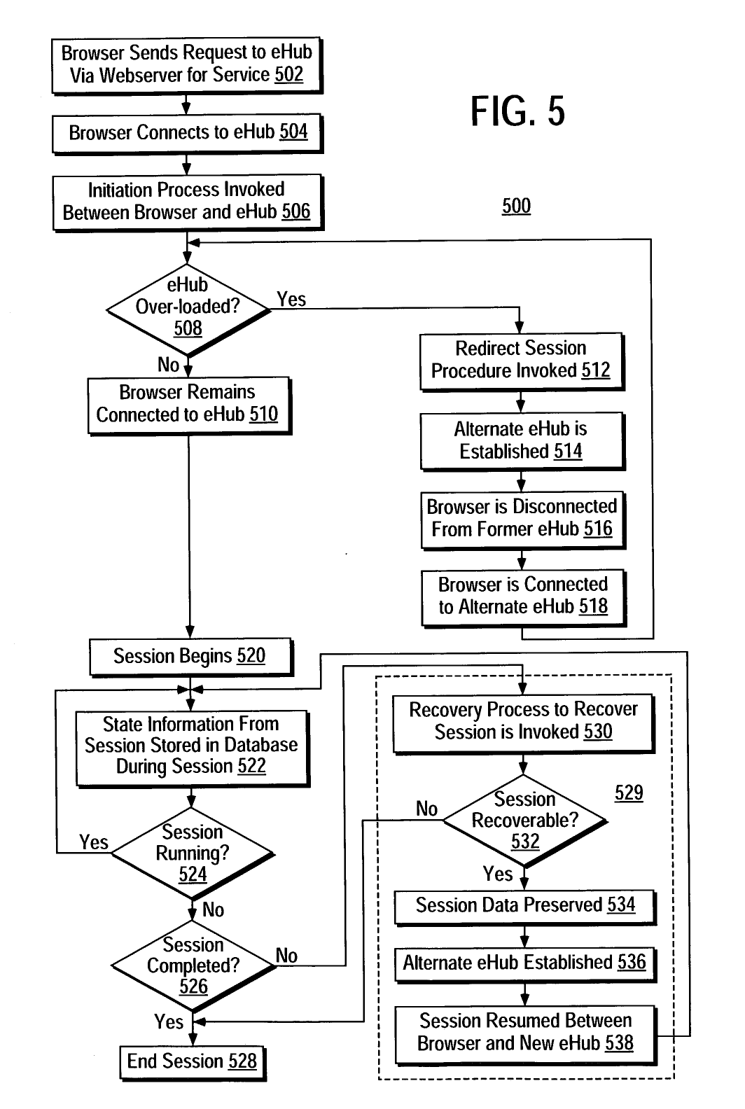

Referring to FIG. 5, a flowchart 500 illustrating one embodiment of a browser and server operation is illustrated. Beginning step 502, a browser sends a request to an eHub for service via the webserver. The request contains the browser address, a target eHub address, possibly a webserver address, and request information (such as data, requested services and processes). The webserver receives the request, then routes it to an eHub indicated in the request. In step 504, a browser communicates with an eHub via the webserver and an initiation process is invoked in step 506 between a browser and an eHub to establish a session connection. In this initiation process, information is transmitted between the webserver and the eHub in an attempt to establish a connection between the browser and the eHub. In this initial process, addresses of other eHubs are transmitted to the webserver for use by the webserver during the initiation process as well as during upcoming sessions. For example, if during the initiation process an eHub is too overloaded to respond to the requests, the webserver may retrieve an alternate address from the list of eHubs and attempts alternate connections with other eHubs connected to the cluster. In another example, if any eHub ceases operation during a session, the webserver may retrieve an alternate address and attempts to reroute the session to another eHub to save the session. In step 508, a load balancing process is performed to determine whether the selected eHub is too overloaded to handle of the browser request. In this process, the webserver queries the eHub to determine whether the eHub as the capacity to handle the request, possibly based on request criteria or other data. In its normal operation, an eHub monitors its current load state so that it can assess whether a browser requests can be serviced when a request is received.

In a preferred embodiment, the load state of each eHub is broadcast to all other eHubs to further aid in load balancing. Other eHubs may then account for the general load status of the cluster. The information may influence whether an eHub will take on a request or pass it off to another eHub. The information may also enable an eHub to transfer and share tasks associated with a request.

If the selected eHub is not overloaded, in step 510 the browser remains connected to the eHub for a session. If, however, the eHub is overloaded, the process proceeds to step 512. In this step, the webserver is configured to retrieve an alternate eHub address from the list of alternate eHub addresses obtained by the webserver during the initiation process. Here, a redirect session procedure is invoked to reroute the request to another eHub. In such procedure, an alternate eHub is established in step 514, where possibly another load balancing process occurs to determine whether the new eHub is overloaded. In this step, the webserver is configured to go from one eHub to another eHub in order to find an eHub that is capable of handling the load required to service the browser request. This process occurs transparently from the user at the browser is, and also occurs automatically until an appropriate eHub is found.

In a preferred embodiment, upon each iteration by the webserver in its search to find an eHub to handle the request, an indicator is incremented in order to indicate the number of eHubs that the webserver has communicated with during the initiation process. In initiating the eHubs, each eHub receives this indicator from the webserver. As webservers search for alternate eHubs, each eHub gives the request a preference as the indicator increases. In each iteration, the browser is disconnected from the former eHub in step 516 and the browser is connected to the alternate eHub in step 518. Once a browser is connected to an eHub, the process returns step 508 to determine whether or not the eHub is too overloaded to respond to the browser requests. This process reiterates itself until an eHub accepts the request.

Once the eHub accepts the request, it is designated as the eHub responding to request, and the session begins his step 520. During the session, the webserver monitors the session. In step 522, state information from the ongoing session is stored in the database throughout the session operations. The storage of the session information in the database enables mutual eHub monitoring, session recovery and eHub process instance recovery. In step 524, a query occurs to determine whether a session is running, which is monitored by the webserver. If the session continues to run, the process returns to step 522 where the state information continually is being kept. Once the session is over, the process proceeds to query 526 determine whether a session is completed. If the session is completed, then the session ends at step 528. If, however, the session is not completed but is not running, then the session is deemed to have been prematurely terminated. The process then returns to step 530 where the recovery processes to recover the session is invoked. Under some circumstances, a session is not recoverable, and data can be lost when the connection with a browser is lost. In a case where an interrupted session is not recoverable, the session is ends at step 528. In such circumstances, the browser and webserver may reconnect with another process instance to restart the session. If the session is recoverable, then the session data is preserved in step 534. An alternate eHub is established in step 536. In such event, another load balancing process may occur in step 536, where it is determined whether or not the alternate eHub is able to take over the session. Once an alternate eHub is established, the session object containing session information is retrieved by the new eHub, and the session resumes at step 538.

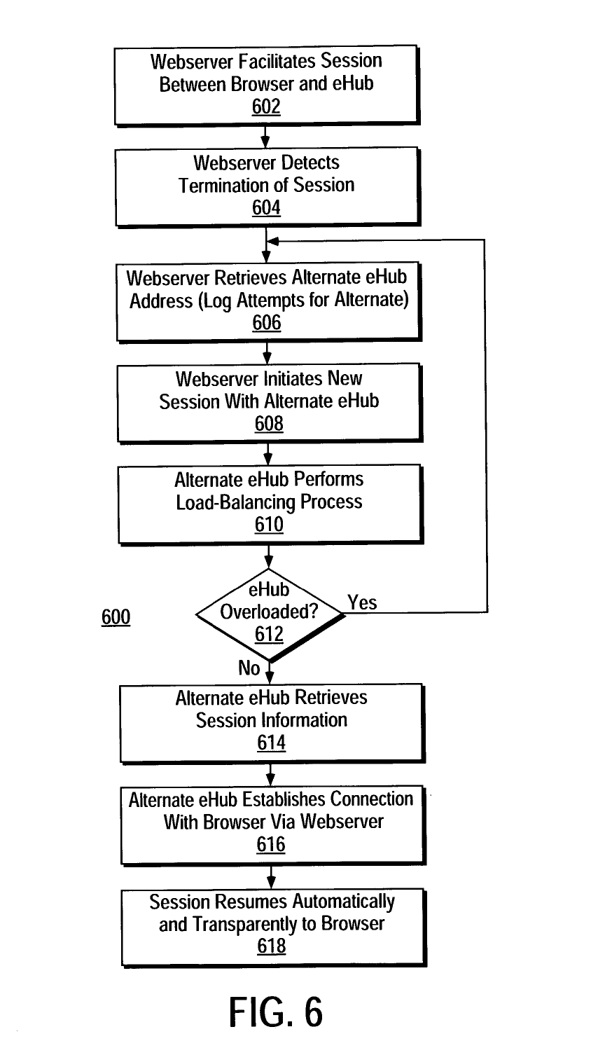

Referring to FIG. 6A, more detailed flowchart of the manner in which a webserver facilitates a session between a browser and an eHub is illustrated. The process 600 begins in step 602, and the webserver detects the termination of a session in step 604. Upon the detection, the webserver retrieves alternate eHub addresses in step 606. Such alternate eHub addresses are available to the webserver, and were retrieved upon the initiation of the session with the eHub. During this process, the webserver logs attempts to find alternate eHubs, creating a history of such attempts. In attempting to initiate sessions with alternate eHubs, each eHub retrieves the log of attempts, assesses the number of attempts made, and gives preference to webservers that have been shopping around for eHubs. This helps to avoid a prolonged session recovery process. In step 608, the webserver initiates a new session with an alternate eHub. Upon initiation, each alternate eHub performs a load balancing process in step 610 to determine whether the alternate eHub can pick up and resume the session with the browser. In the process, the eHub determines in step 612 whether it has the capacity to take over the browser session. If an eHub overloaded, the process returns to step 606, where other alternate eHubs are sought out. If an eHub is found that is not overloaded, the process proceeds to step 614, where the alternate eHub retrieves the session information from the prematurely terminated session. Such information may include the browser log-in information, the session, the session request, and other information necessary or useful for the new eHub to take over the session. The amount of information stored for use n recovery of a premature termination is determined on the particular application. In a preferred embodiment, the amount of information is chosen to keep the access traffic to the database at a minimum. Once this is retrieved, the alternate eHub establishes a communication connection with the browser via the webserver in step 616. In step 618, the session resumes automatically and transparently to the browser. The webserver also continues to monitor the session. Referring again to FIG. 5, in step 538, the process returns to step 522 where the new session information is stored in database during the session.

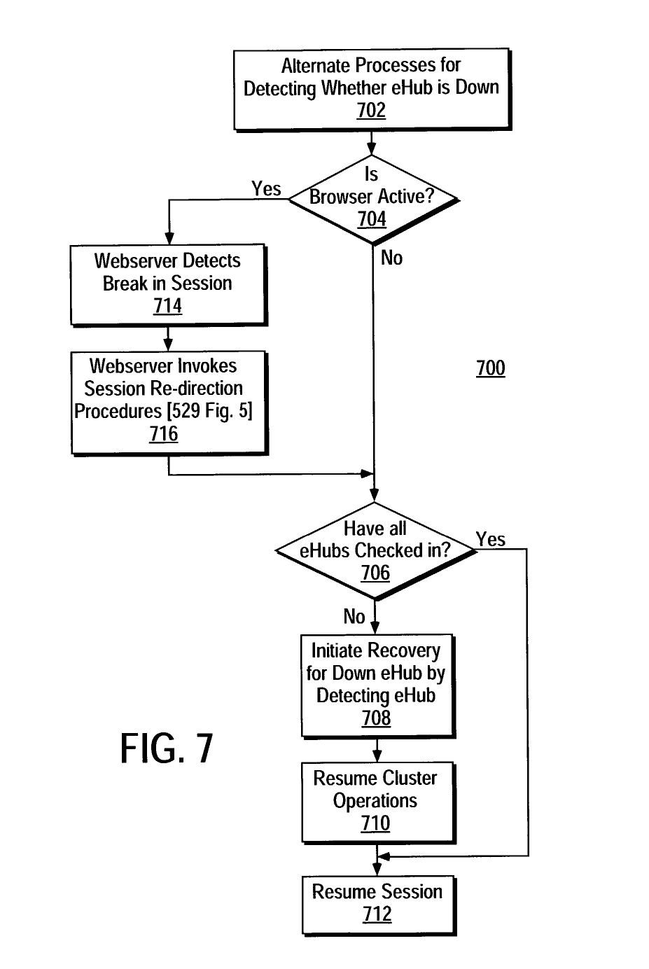

Referring to FIG. 7, a flowchart 700 is shown illustrating alternate processes for detecting whether an eHub is down. The recovery processes chosen depends on which state any one eHub is in. For example, if an ongoing session is occurring, the browser session must be redirected to another eHub, and attempts must be made to continue the session with another eHub. In step 704, it is determined whether the browser is active. If a browser is not active in a session with the particular eHub, it is not able to initiate an eHub crash detection. Therefore, the system assumes that an active session is not occurring, or that the browser is idle, or has otherwise suspended operations. Therefore, the webserver would not be aware of whether a session has been prematurely terminated. In step 706, it is determined whether all the eHubs have checked in, indicating that they are up and running in viable. If any eHub has not checked in, the process proceeds to step 708 where recovery for any down eHub is initiated. This is performed by an eHub that detects that a particular eHub is not checked in with its heartbeat signal, indicating that it is down. In this process, more than one eHub may detect the down eHub, but only one recovery takes place. Once the recovery operations have been completed, the process proceeds to step 710, where cluster operations are resumed, then to step 710 where the session is resumed. In the operation, where a browser is active in step 704, then the webserver is most likely to first detect a premature termination of a session in step 714. This occurs because the webserver is the mediator between a browser and an eHub and is the first to detect whether or not an active session has prematurely terminated. The process then proceeds to step 716 where the webserver invokes a session redirection procedure, such as the redirection procedure 529 discussed above in connection with FIG. 5. When the webserver involves a session redirection to the alternate eHub, the alternate eHub will communicate with other eHubs to detect that an eHub is down. Once a session has been redirected, the process proceeds to step 708 as discussed above.

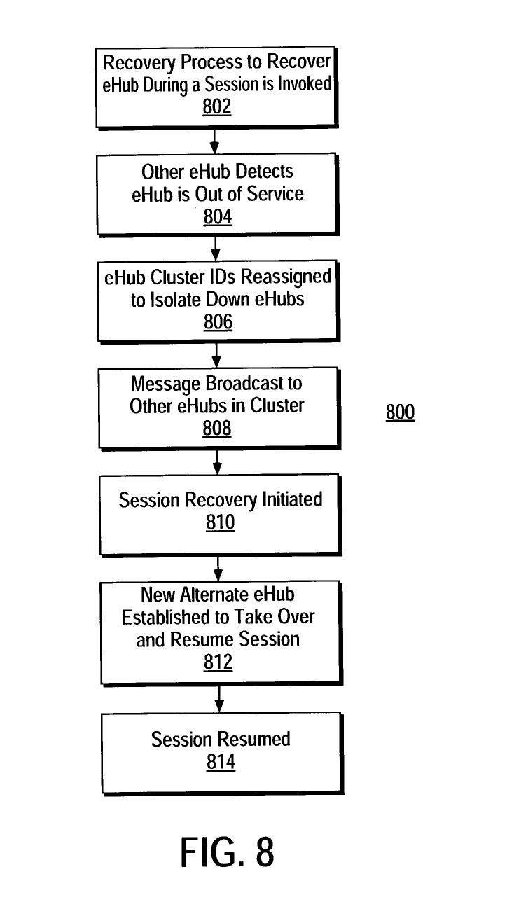

Referring to FIG. 8, a flowchart 800 is shown illustrating the recovery process for recovering a session. In step 802, the recovery process to recover a session is invoked. In step 804, an eHub in the cluster determines whether an eHub is out of service by detecting that the heartbeat has not been received at the database on a periodic schedule. In step 806, the eHub cluster IDs are reassigned, and the eHub that is out of service is effectively isolated from the cluster. The eHub is then unable to receive requests or access the database within the cluster. In step 808, a message is broadcast from the eHub that detected the down eHub to all the other eHubs the cluster. This announces the down eHub status to all of the other eHubs, each of which can then update their local administrative directories to account for lost eHub. In step 810, the session recovery is initiated. In step 812, an alternate eHub is established to take over and resume the session. In step 812, the session is resumed.

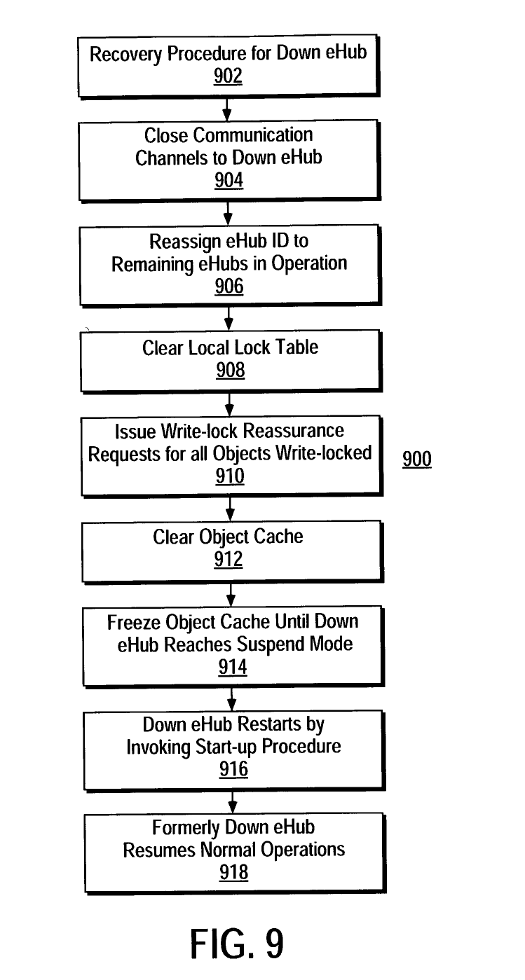

Referring to FIG. 9, a flowchart 900 is shown to illustrate the recovery procedure for an eHub that has shut down. In step and 902, the procedure begins to recover the down eHub. In step 904, all communication channels to the down eHub are closed to avoid any further communication to or from the down eHub. This protects both the down eHub as well as other entities that rely on the eHub for sending false signals and avoids storing corrupted or otherwise invalid information. In step 906, all remaining eHubs are reassigned an eHub ID. This resets the administrative directory so that all of the remaining eHub in the cluster are accounted for. In step 908, the local lock table is cleared In a preferred embodiment, object lock distribution is determined by eHub ID assignment. This enables the ability to quickly determine which eHub is the synchronization server of any given object. This obviates the need to communicate with other eHubs to confirm which eHub is in fact the synchronization server. In operation, reassignment of eHub IDs will cause different lock distributions. In other words, once the eHub IDs are reassigned within the cluster, the designations of synchronization servers (i.e. which eHubs are designated as the synchronization server for particular objects) may change. This occurs, for example, when an eHub terminates services, or is otherwise taken out of service within the cluster. Therefore, a local lock table has to be cleared to pave the way of re-determination of an object's synchronization server. In step 910, write-lock reassurance requests are sent out for all objects that are write-locked In a preferred embodiment, clearing local lock table only enables the system to re-determine the synchronization server of each writelocked object. In the process of instance recovery, the write lock of an object should not be relinquished. Write-lock reassurance is a process of finding a new synchronization server for each writelocked object while at the same time retaining the write lock of the object. This preserves the integrity of each object's data. The step 912, the object cache is cleared in step 914 until the down eHub reaches to suspend mode. In step 916, the down eHub restarts by invoking a start-up procedure, such as that discussed above in connection with FIG. 3. In step 918, the formerly down eHub resumes normal operations as part of the eHub cluster again.

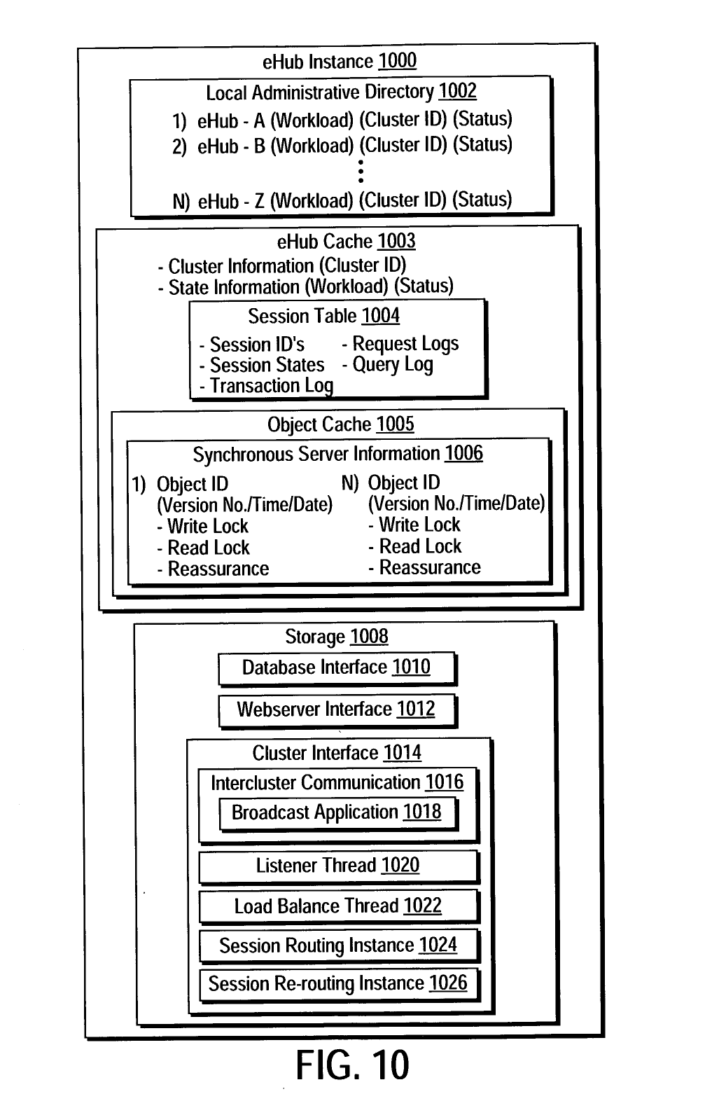

Referring to FIG. 10, an example of an eHub instance 1000 is illustrated. The eHub instance includes administrative directory 1002 containing information related to other eHubs, including status information. For example, the administrative directory may include the identification of an eHub, such as “eHub-A”, and may include workload information, cluster identification and status information, such as whether the particular eHub is in operation. Such status information may include a timestamp of when a particular eHub last sent a heartbeat transmission to the database administrative directory. Such information is used by the eHub in monitoring other eHubs. The eHub instance further includes an eHub cache 1003 for storing frequently used information by the eHub instance. The eHub cache includes cluster information, including the cluster ID of the eHub instance, and further includes state information including the eHub instance's workload and status information. This information is transmitted periodically to the database for storage in its centralized administrative directory.

The eHub cache includes a session table 1004 that includes information pertaining to an ongoing session. The session table may include session IDs that identify the particular session, as well as session states that define state information pertaining to a session. Request logs, query logs and transaction logs may also be included in the session table, which all define the different requests, queries and transactions that may have occurred during a session. If an eHub instance prematurely terminates a session, this information may be useful to an alternate eHub instance that may take over the session. For practical purposes, some session information in the session table may or may not be transmitted to the database for storage. To do so might unduly burden a database by taking up an unnecessary amount of space, or might overload the access traffic to the database. However, in the event that an eHub is being taken out of operation by an eHub cluster monitor, precautions may be made so that the entire session object from the terminating eHub may be transferred to the recovering eHub instance. Thus, the entire session table may be transmitted to another eHub instance that would take over the session.

The eHub cache further includes an object cache 1005 for storing objects of which the eHub instance is designated as the synchronous server. According to the invention, the cache storage of each eHub is synchronized with other eHubs to avoid contention in modifying objects stored in the database. The object cache includes synchronous server information 1006 that contains information pertaining to such objects. In operation, each eHub acts as the synchronous server to particular objects exclusively. The eHub instance that accesses the synchronous server to particular object is able to govern the ability of other eHubs to modify the object. When an eHub receives a request that involves the access of an object stored in the database, it first determines whether a version of the object is stored in its own cache. If it is stored in the eHub's cache, it then determines whether or not the eHub is the synchronous server for the object. If the eHub is not synchronous server, it must communicate with the eHub that is designated as the synchronous server for the object. This allows a remote eHub in the cluster to read or write to an object with permissions from the synchronous server. If the eHub is the synchronous server, it has the ability to write lock others from modifying the object, and maintains the ability to govern such modifications. These configurations prevent an object from being corrupted with conflicting write operations, and gives assurance to other eHubs that the information in the object is current. If the particular object is being accessed by eHub, then the eHub instance may assert a write lock to avoid any modifications during an access. The eHub instance acting as the synchronous server has the ability to release a write lock, allowing another eHub to modify the object within the database. In any case, according to the invention, each eHub will need at most one round-trip of communications between itself and the synchronization server to complete the lock operation, regardless of the number of eHub instances in the cluster. The significance of this is to ensure virtually infinite number of eHub instances joining the cluster without excessive communication overhead. Thus, the invention provides for robust scalability of an eHub cluster, where large numbers of eHubs can associate with and synchronize with other eHubs within the cluster. The eHub instance may also issue a read lock, which keeps other eHubs from reading the object under certain situations. For example, an object may be undergoing a modification that would possibly affect other eHubs. In such a situation, it may be wise to prevent other eHubs from reading the object. When an eHub is contacted by another eHub that wishes to access particular objects, the eHub that access the synchronous server for the object may send a reassurance message to assure the requesting eHub that the version of the obtained in its cache is current.

The eHub instance further includes other storage 1008 for storing applications used by the eHub operating within the cluster. The storage includes database interface 1010 that enables the eHub instance to perform queries and transactions with a database. The storage may also include webserver interface 1012 that enables the eHub instance to communicate with a webserver managing sessions. Storage further includes cluster interface 1014 that includes applications for enabling operations within the cluster, including communications with other eHubs. This enables cache synchronization by enabling them to synchronize each other's access to objects in which they are acting as synchronization servers. The cluster interface includes inter-cluster communication application 1016 that enables the eHub to communicate with other eHubs for various operations. The inter-cluster communication application includes a broadcast application 1018 for broadcasting information related to eHub status to other eHubs within the cluster. The cluster interface further includes listener thread 1020 for receiving signals transmitted from other eHubs that wish to communicate with the eHub instance. Load balancer thread 1022 is configured to monitor and retain information pertaining to the workloads of the eHub instances well as other eHubs within the cluster. The cluster interface includes a session routing instance 1024 configured to enable the eHub instance to reroute its ongoing session in response to a scheduled shutdown of the eHub instance. The eHub instance may further include a session rerouting instance 1026 for rerouting such sessions.

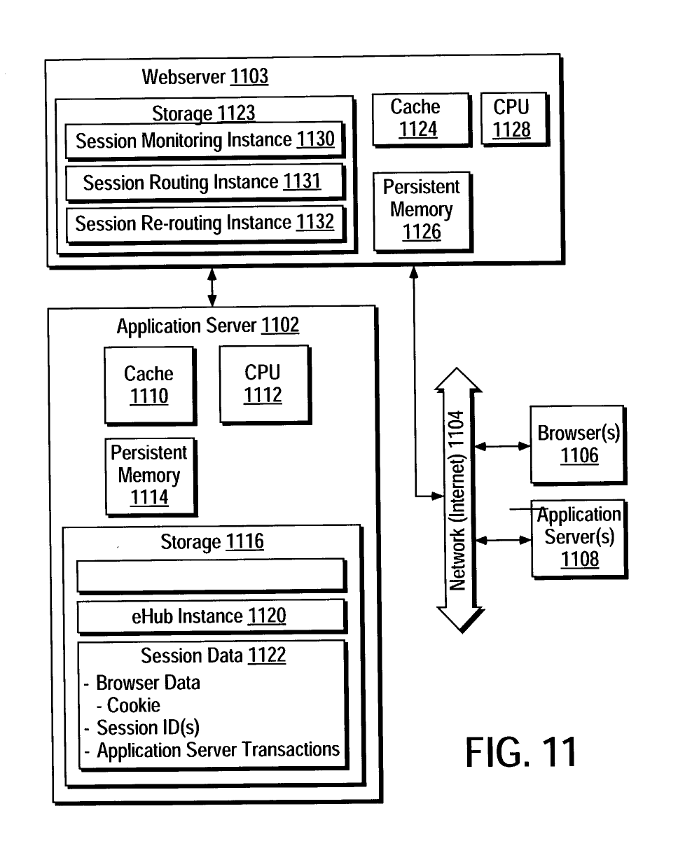

Referring to FIG. 11, a block diagram is shown illustrating a system 1100 according to the invention. Generally, the system includes an application server 1102 that communicates with webserver 1103. The webserver communicates via network 1104 with browsers 1106 and application servers 1108. The application server includes a cache memory 1110 configured to store frequently used information, including eHub instances 1000 (FIG. 10). The application server further includes CPU 1112 configured to govern operations of the application server by executing software applications stored in the application server. The application server further includes persistent memory 1114 for storing frequently used, but seldom changing data. The application server further includes storage 1116 for storing applications executed by the CPU. Browser interface application 1118 enables the application server to interface with browsers via the webserver. EHub instances 1120 are stored in the application server, which acts as the eHub instance's host. The application server further includes session data 1122 that includes data pertaining to ongoing sessions. Such data may include browser data pertaining to browsers that send requests to the application server via the webserver. The session data may further include browser cookies that leave certain property data of the browser entity 1106, allowing the application server to communicate with the entity. The session data may further includes session IDs as well as application server transactional information. The application server further includes any other eHub instance information, such as that illustrated in FIG. 10.

The webserver 1103 includes storage 1123 for storing applications and other information related to webserver operations. The webserver further includes cache storage 1124 for storing frequently accessed information that may be modified during webserver operations. The webserver further includes persistent memory 1126 for storing information that is frequently accessed, but seldom changes. The webserver also includes a CPU 1128 configured to execute software stored in storage 1123 to enable the operations of the webserver. The storage 1123 includes session monitoring instance 1130 configured to enable the webserver to monitor ongoing sessions. The storage further includes session routing instance 1131 configured to interface application servers or other entities hosting process instances to route browser requests. The storage further includes session rerouting instance 1132 configured to enable a webserver to reroute sessions in the event of a premature termination of an eHub instance.

Referring to FIG. 12, a process for acquiring a write lock of an eHub is illustrated. The write lock operations of the invention enable the synchronization of the caches of each eHub. Each eHub generally acts as a synchronization server for particular objects, governing any proposed modifications by other eHubs. The process begins in step 1202, where a write lock is acquired. In step 1204, the eHub searches its local object cache for a desired object. The object may or may not be stored in the local object cache, and the eHub may or may not be the synchronization server for the particular object. If it is the synchronization server for the object, the eHub would have a write lock privilege to govern write locks for the object. If it does have the privilege, which means either that that it is the synchronization server or that the synchronization server already gave it a write lock privilege, the process proceeds to step 1208, where the eHub conducts write operations. The process then ends. If, however, the eHub does not have the write lock privilege, the process proceeds to step 1210 were it is determined whether or not the eHub is the synchronization server for the target object. If it is the object synchronization server, the process proceeds to step 1212 where the object is stored and indicated as write locked in the eHub's local lock table. The process then proceeds to step 1208, where the write lock operations are conducted, and the process ends. If the eHub is not the synchronization server, step 1210 proceeds to step 1214, where write lock permission is obtained from the object's synchronization server. The process then proceeds to step 1216 where the synchronization server for the object is identified by the requesting eHub. The process then proceeds to step 1218 where a communication handle is required for the synchronization server by the requesting eHub. The eHub then sends a request to the synchronization server for a write lock in step 1220. Once permission to write lock is received from the synchronization server in step 1222, the process proceeds to step 1208 where write operations are conducted. The process then ends.

In a preferred embodiment, the administration instance 108 (FIG. 1) operates as a cluster configuration tool. A designated eHub instance may operate the administrator as a cluster configuration tool to perform administrative operations. This provides management capability for all the eHub instances in the cluster. In a preferred embodiment, the administrative instance is configured as an administrative node tree. The tree may reside in an application server that hosts the process instances. In such an application, cluster-specific properties may be established as properties of this node. In operation, an application may be configured to allow a user to access the administrative instance to log on, to add or remove subnodes, or otherwise administer the cluster. In a preferred embodiment, the database is established as the root node for the administrator node tree. However, many eHub specific properties will be retained and maintained by the administration instance. Thus, the cluster specific properties are maintained by the administration instance. Such properties may include different handles for initial database connections, maximum database connections, and other connection information. The properties may also include different information pertaining to the synchronous cache storages of each of the eHub. Such information may include the time periods in which an object is maintained in a particular cache. Generally, the information maintained by the administration instance is selected to reduce the flow of access traffic to the database by eHubs within the cluster.

In a preferred embodiment of the eHub cluster monitor 110 (FIG. 1), a direct connection is made between eHub cluster monitor, the individual eHubs and the database. Upon and initiation other eHub monitor, a list of all eHubs in the cluster are retrieved from the database from the administrative directory of the database. Alternatively, the eHub cluster monitor may log on to an eHub directly, where the eHub is up and running and has a current local administrative directory.

One useful operation of the eHub cluster monitor is the ability to shut down particular eHubs in the cluster. This can be useful for maintenance of eHubs, termination of troubled eHubs and other administrative purposes where eHubs need to be shut down. Planned or scheduled shutdowns can occur, and active browser sessions may be rerouted when possible. In a preferred embodiment, user sessions are always rerouted when possible. The process begins in Step 1302, where the process to shut down an eHub by an eHub cluster monitor is illustrated. In step 1304, it is determined which type of shutdown has occurred. In the first type of shutdown, the normal shutdown, the eHub cluster monitor has the ability to mediate any disruptions that such a shutdown may cause. In step 1306, any new browser logins are blocked. This prevents any new sessions from occurring, avoiding any session terminations as a result of any shutdowns. In step 1308, it is determined whether the eHub being shut down is the only eHub that is operational in the cluster. If other eHubs are operational within the cluster, then the process proceeds to step 1314, where any ongoing sessions with the eHub being shut down are rerouted to other eHubs within the cluster. The process then proceeds to Step 1316, where the eHub is shut down. The eHub is restarted in Step 1318. If the browser being shut down is the only eHub that is up and operational, then shutting it down would be disruptive browsers, leaving no other eHub to handle incoming browser requests. The process loops between the query step 1310 and wait period, Step 1312, until another eHub is made operational within the cluster. Once another eHub is up and running within the cluster, the eHub is shut down in Step 1316, and is restarted in Step 1318.

Referring back to step 1304, in an abort type of shutdown, all new sessions are blocked in Step 1320. It is then determined in Step 1324 whether the eHub being aborted is the only eHub that is up and running. If it is the only eHub up an running, all sessions are terminated in Step 1326, and the eHub is shut down in step 1330. If, however, other eHubs are up and running in the cluster, the eHub's sessions are rerouted to other eHubs in Step 1328, and the eHub is shut down in Step 1330.

Referring again back to Step 1304, if an immediate type of shutdown occurs, then all new session requests directed to the eHub are blocked in Step 1332, and all outstanding session requests are completed in Step 1334. The process proceeds to Step 1324 to determine whether the eHub being shut down is the only eHub up and running within the cluster. If it is the only one up and running, then all sessions are terminated in Step 1326, and the eHub is shut down in Step 1330. If other eHubs are up an running within the cluster, then Step 1324 proceeds to Step 1328, and all of the eHub's sessions are rerouted to other eHubs to resume the sessions. The eHub is then shut down in Step 1330.

In general, embodiments of the invention may include the utilization of dedicated processors, webservers configured to receive and route browser requests, application servers, state servers and other types of computer processors configured to communicate amongst each other and that may be connected to one or more networks, including a Local Area Network (LAN), an intranet and the Internet. However, it will be appreciated by those skilled in the art, implementation of such devices and systems are but few illustrations of the utility of the invention, and that the invention may have greater applicability and utility in many other applications where efficient routing and processing of data within one or more networks is involved. Equivalent structures embodying the invention could be configured for such applications without diverting from the spirit and scope of the invention. Although this embodiment is described and illustrated in the context of devices and systems for exchanging data among users of a computer system or network, the invention extends to other applications where similar features are useful. The invention may include personal computers, application servers, state servers or Internet webservers that are designed and implemented on a computer and may be connected to a network for communication with other computers to practice the invention.

If on a separate computer, it will be apparent that the client processor is conventional and that various modifications may be made to it. Data can be stored in the database, or may optionally be stored in data files, which gives a user an organized way to store data. The client processor may also include a conventional operating system, such as Windows, for receiving information to develop and maintain.

The invention may also involve a number of functions to be performed by a computer processor, such as a microprocessor. The microprocessor may be a specialized or dedicated microprocessor that is configured to perform particular tasks by executing machine-readable software code that defines the particular tasks. Instances may be defined on various and different entities in an application, where the instances define processes or operations for providing functionality. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices or process instances required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of computers, such as computer servers, that utilize the invention, there exist different types of storage and memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

The invention is directed to a system and method for receiving, monitoring and serving browser requests to a cluster of process instances, possibly hosted in an application server. It will be appreciated by those skilled in the art, that the embodiments described above are illustrative of only finite utility of the invention, and that the invention has greater applicability and utility in many other applications where efficient routing, monitoring and processing of data within one or more networks is involved. Equivalent structures embodying the invention could be configured for such applications without diverting from the spirit and scope of the invention as defined in the appended claims. Although this embodiment is described and illustrated in the context of application servers serving browser requests, the invention extends to other applications where similar features are useful. Furthermore, while the foregoing description has been with reference to particular embodiments of the invention, it will be appreciated that these are only illustrative of the invention and that changes may be made to those embodiments without departing from the principles of the invention, the scope of which is defined by the appended claims.

1. A system configured to facilitate communication between a browser and a process instance, the process instance being configured to run computer processes for performing communication operations, the browser having a network interface for communicating with entities via a network, which may include an application server, comprising:
a cluster of multi threaded process instances, wherein each instance is configured to communicate with a browser sending a browser request, to access a database, and to communicate with and monitor other process instances in the cluster; and
a cluster monitoring instance configured to monitor the operating states of each instance in the cluster and to enable state-related operations among the instances of the cluster.

2. A system according to claim 1, wherein each process instance making up the cluster of multi threaded process instances is configured to determine whether another process instance has terminated operation, and is configured to facilitate recovery of the operation of a process instance that has terminated operation.

3. A system according to claim 1, wherein the cluster monitoring instance is configured to determine whether a process instance has terminated operation, and wherein the monitoring instance further includes a recovery mechanism configured to facilitate recovery of the operation of a process instance that has terminated operation.

4. A system according to claim 1, wherein the cluster monitoring instance is configured to perform scheduled termination of operation of a process instance, and wherein the monitoring instance further includes a recovery mechanism configured to facilitate recovery of the operation of the terminated process instance.

5. A system according to claim 1, further comprising a session monitoring instance configured to monitor a session between a process instance and a browser, wherein the session monitoring instance is configured to determine whether the process instance has terminated operation during the session, and wherein the session monitoring instance further includes a recovery mechanism configured to facilitate recovery session with an alternative process instance.

6. A system according to claim 1, further comprising a routing instance configured to route incoming browser requests to process instances, a session monitoring instance configured to monitor a session between a process instance and a browser, wherein the session monitoring instance is configured to determine whether the process instance has terminated operation during the session, and a recovery mechanism configured to facilitate recovery session with an alternative process instance.

7. A system according to claim 1, further comprising a webserver configured to facilitate a session between a browser and a process instance, the webserver including a session routing instance configured to route incoming browser requests to process instances, a session monitoring instance configured to monitor a session between a process instance and a browser, wherein the monitoring instance is configured to determine whether the process instance has terminated operation during the session, and wherein the webserver further includes a recovery mechanism configured to facilitate recovery session with an alternative process instance.

8. A system according to claim 7, further including a rerouting instance configured to send browser session information to an alternative process instance in the event of a premature end of a session.

9. A system according to claim 7, further comprising a session recovery mechanism configured to transfer browser session information to another process instance in the event of a premature termination of process instance operation, wherein the other process instance is configured to assume and resume the browser session in a manner that is transparent to a user operating a browser device.

10. A system according to claim 1, wherein each process instance has access to cache storage, and wherein the cluster of multi threaded instances are configured to synchronize access to objects stored in cache storage.

11. A system according to claim 1, wherein each process instance has access to cache storage, and where the access to an object that is accessible by the cluster of multithreaded process instances is governed by a synchronization server to maintain the integrity of the object.

12. A system according to claim 1, further comprising a session monitoring instance configured with a monitoring mechanism that allows a webserver to monitor activities of a session between a process instance and a browser.

13. A system according to claim 1, further comprising a webserver configured monitor and to redirect a session that is occurring between a process instance and a browser and that is being monitored to another process instance to take over the ongoing session.

14. A system according to claim 1, further comprising an administrative instance configured to govern the settings of the cluster of process instances.

15. A system according to claim 1, wherein the cluster of process instances are configured to communicate with a database, the database having an administrative directory configured to contain status information of each process instance within the cluster of process instances.

16. A system according to claim 1, wherein the cluster of process instances are configured to communicate with a database, the database having an administrative directory configured to contain status information of each process instance within the cluster of process instances, wherein a process instance is configured to retrieve status information from the administrative directory to determine whether another process instance has terminated operation.

17. A system according to claim 1, wherein the cluster of process instances are configured to communicate with a database, the database having an administrative directory configured to contain status information of each process instance within the cluster of process instances, wherein a process instance is configured to retrieve status information from the administrative directory to determine whether another process instance has terminated operation and configured to initiate a recovery process in the event that another process instance has terminated operation.

18. A system according to claim 15, wherein the process instances is configured to communicate with the database to send status information to be stored in the administrative directory, the process instance having a local cache storage and a local administrative directory, and wherein the process instance is configured to retrieve status information from the administrative directory by copying the status information of another process instance into a local administrative directory.

19. In a system including a server being configured to run instances of computer processes for performing communication operations, such as transactions with a database for example, and a browser having a network interface for communicating with entities via a network, which may include an application server, a method of facilitating communication between a browser and a process instance, comprising:
receiving a request from a webserver for a browser session with a process instance;
establishing a monitoring thread that allows a webserver to monitor the browser session between the browser and the process instance;
initiating a browser session between the browser and the process instance;
monitoring the browser session; and
if the session prematurely terminates, redirecting the ongoing session to an alternate process instance.

20. A method according to claim 19, further comprising
determining an object to be accessed in response to the request from the webserver;
searching a local object storage for the object; and
determining whether the process instance has write lock privilege to write lock the object.

21. A method according to claim 20, further comprising:
if the process instance has write lock privilege, conducting write operations on the object.

22. A method according to claim 20, further comprising, if the process instance does not have write lock privilege, and if the process instance is the synchronization server, storing the object as write locked in the local lock table, and conducting write operations on the object.

23. A method according to claim 20, further comprising, if the process instance does not have write lock privilege, and if the process instance is not the synchronization server, obtaining write lock permission from the object's synchronization server by:
identifying the synchronization server for the object;
acquiring a communication handle for the synchronization server;
sending a write lock request to the synchronization server;
receiving permission to write lock the object from the object's synchronization server; and
conducting write operations on the object.

24. A method according to claim 19, wherein redirecting the ongoing session to an alternate process instance includes:
locating an alternate process instance to assume the browser session;
transferring the session information to the alternate process instance;
resuming the browser session between the browser and the alternate process instance; and
monitoring the browser session.

25. A method according to claim 19, further comprising:
determining whether a process instance has terminated operation, and
if the process instance has terminated operation, recovering the operation of a process instance that has prematurely terminated operation.

26. A method according to claim 19, further comprising:
if the workload of the process instance cannot accommodate the request for the browser session, rejecting the request for the browser session; and
if the workload of the process instance can accommodate the request for the browser session, establishing a monitoring thread that allows a webserver to monitor the browser session between the browser and the process instance.

27. A method according to claim 19, further comprising transferring browser session information to another process instance in the event of a premature termination of process instance operation, and assuming and resuming the browser session in a manner that is transparent to a user operating a browser device.

28. A method according to claim 19, further comprising receiving a monitoring thread from an application server so that the webserver can monitor the activities of a process instance during a session between the process instance and a browser.

29. A method according to claim 19, wherein redirecting a session further comprises:
assuming a session by an alternate process instance;
engaging the alternate process instance with a monitoring mechanism; and
monitoring the session between the alternate process instance and the browser.

30. In a system including a server being configured to run instances of computer processes for performing communication operations, such as transactions with a database for example, and a browser having a network interface for communicating with entities via a network, which may include an application server, a method of maintaining objects for access among a cluster of process instances, comprising:
determining an object to be accessed;
searching a local object storage for the object; and
determining whether the process instance is the synchronous server for the object by determining whether the process instance has write lock privilege to write lock the object.

31. A method according to claim 30, further comprising:
if the process instance has write lock privilege, conducting write operations on the object.

32. A method according to claim 30, further comprising, if the process instance does not have write lock privilege, and if the process instance is the synchronization server, storing the object as write locked in the local lock table, and conducting write operations on the object.

33. A method according to claim 30, further comprising, if the process instance does not have write lock privilege, and if the process instance is not the synchronization server, obtaining write lock permission from the object's synchronization server by:
identifying the synchronization server for the object;
acquiring a communication handle for the synchronization server;
sending a write lock request to the synchronization server;
receiving permission to write lock the object from the object's synchronization server; and
conducting write operations on the object.

34. In a system including a server being configured to run instances of computer processes for performing communication operations, such as transactions with a database, and a browser having a network interface for communicating with entities via a network, a method of facilitating the operation of a process instances configured to respond to browser requests, comprising:
monitoring a cluster of process instances by retrieving an administrative directory from a central location;
analyzing the administrative directory to determine whether any other process instances have terminated operation; and
if a process instance has terminated operation, initiating a recovery process to recover the operations of the process instance that has terminated operation.

35. A method according to claim 34, wherein the recovery process includes isolating the process instance that has terminated operation.

36. A method according to claim 34, wherein isolating the process instance includes reassigning identification information for other process instances in the cluster to avoid browser requests being routed to the process instance that has terminated operation.

37. A method according to claim 34, wherein the recovery process includes establishing an alternate process instance to take over any ongoing session occurring when the process instance terminated operation.

38. A method according to claim 34, wherein the recovery process includes
isolating the process instance that has terminated operation by:
clearing the local lock table of the process instance;
issuing a write lock reassurance requests for any objects that are write locked; and
freezing the object cache of the process instance that has terminated operation.

39. A method according to claim 34, wherein the recovery process further includes invoking a start-up procedure for the process instance that has terminated operation.

40. A method according to claim 34, further comprising:
if a process instance experiences a normal shutdown,
blocking any new logins for browser requests;
determining whether alternate processes are operating;
if no alternate process instances are operating, waiting until an alternate process instance arises;
if an alternate process instance is operating, rerouting ongoing sessions to an alternate process instance; and
shutting down the process instance.

41. A method according to claim 34, further comprising:
if a process instance experiences an abort shutdown,
blocking any new browser session requests;
determining whether alternate processes are operating;
if no alternate process instances are operating, terminating any ongoing sessions;
if an alternate process instance is operating, rerouting ongoing sessions to an alternate process instance; and
shutting down the process instance.

42. A method according to claim 34, further comprising:
if a process instance experiences an immediate shutdown,
blocking any new browser session requests;
completing any ongoing sessions;
determining whether alternate processes are operating;
if no alternate process instances are operating, terminating any ongoing sessions;
if an alternate process instance is operating, rerouting ongoing sessions to an alternate process instance; and
shutting down the process instance.
